(19) United States
(12) Patent Application Publication
(10) Pub. No.: US 2026/0158379 A1
(43) Pub. Date: Jun. 11, 2026

(54) AI GENERATED GAME SUMMARY

(71) Applicant: Sony Interactive Entertainment Inc., Tokyo (JP)

(72) Inventors: Todd Kozuki, San Mateo, CA (US); Jason Wang, San Mateo, CA (US); Masanori Omote, San Mateo, CA (US); Oliver Capio, San Mateo, CA (US); Manoj Kumar Srivastava, San Mateo, CA (US)

(21) Appl. No.: 18/975,308

(22) Filed: Dec. 10, 2024

(51) Int. Cl. A63F 13/497; A63F 13/67

(52) U.S. Cl. CPC A63F 13/497; A63F 13/67

(57) ABSTRACT

Artificial intelligence (AI) in the form of machine learning (ML) models may be used to aggregate and digest video game play factors to produce a report to game developers identifying appealing and unappealing parts of a video game.

### FIELD

The present application relates generally to artificial intelligence (AI) generated game summaries.

### BACKGROUND

Video games have become sophisticated and complex. Developers of video games consequently desire to understand what particular parts of video games are appealing to gamers and which may not be as appealing.

### SUMMARY

As understood herein, owing to the growing complexity and sophistication of video games, a large number of factors may interplay with each other when trying to understand what makes a particular scene or entire game appealing to gamers.

Accordingly, an apparatus includes at least one processor system configured to input to one or more machine learning (ML) models information related to play of a computer game, and execute the one or more ML models to generate a report identifying at least a first portion of the computer game having a first quality and at least a second portion of the computer game having a second quality.

The information input to the ML model(s) can include one or more of captured clips of the computer game, number of views of the captured clips, number of views of clips similar to the captured clips, captured comments of gamers playing the computer game, text related to the captured clips, and internet comments related to the computer game.

In some examples the processor system can be configured to change the computer game using output of the one or more ML models.

In example embodiments the report is a first report and the information includes one or more questions derived from the first report to cause the one or more ML models to generate a second report.

In another aspect, an apparatus includes computer memory that is not a transitory signal and that in turn includes instructions executable by at least one processor system to identify text related to play of a computer game. The instructions are executable to input the text to one or more machine learning (ML) models, and use output of the one or more ML models to change the computer game.

In another aspect, a method includes inputting information related to plural game play sessions of a computer game to one or more ML models, and executing the ML models to output indication of game play.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates example overall logic in example flow chart format;

FIG. 3 illustrates a first example ML architecture;

FIG. 4 illustrates a second example ML architecture;

FIG. 5 illustrates example training logic in example flow chart format; and

FIG. 6 illustrates an example report.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single-or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

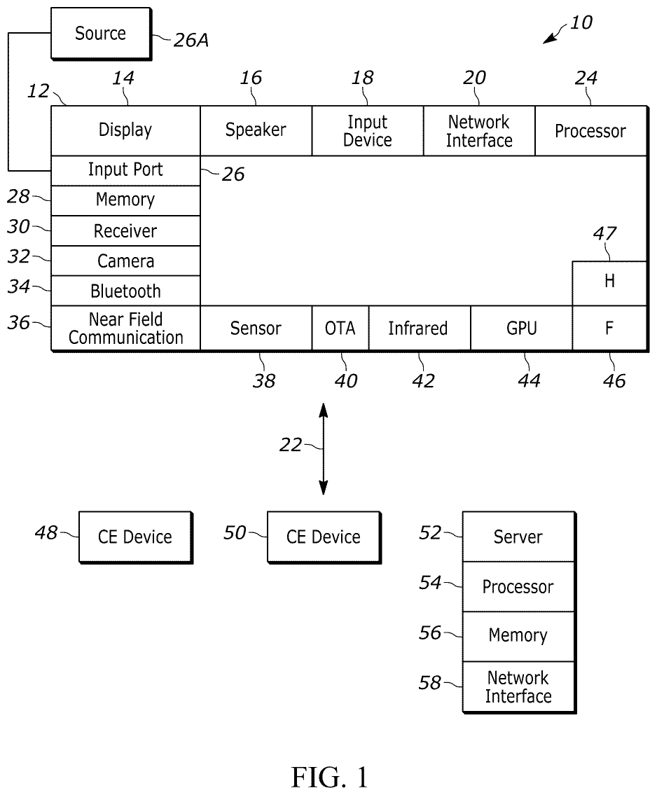

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth^{®}transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

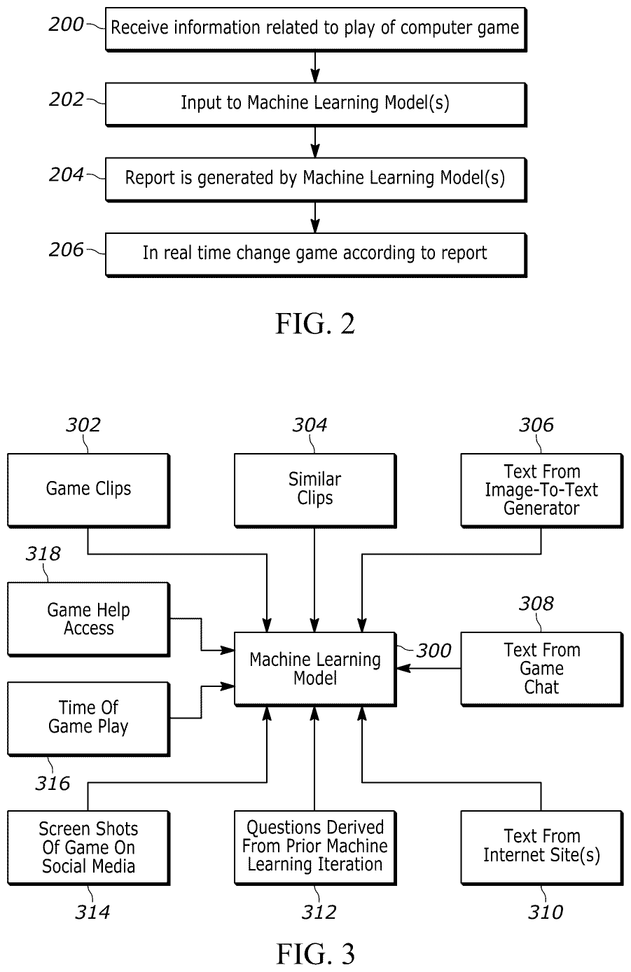

Refer now to FIG. 2, which shows overall example logic for generating reports for developers using captured clips, number of views of clips/similar clips, captured comments and text of clips (keywords), external sites (video streams, comments) that may be executed daily or hourly to generate reports. Commencing at state 200, information related to play of a computer game is received, such as any of the information described herein. Proceeding to state 202 the information is input to one or more machine learning (ML) models such as large language models or more generally generative models which in response generates, at state 204, a report regarding game play to a developer or other interested party. If desired, the logic may move to state 206 to, in real time or near-real time, change the computer on the fly based on information in the report. The report, which may be in text and/or audio and/r still image and/or video form, essentially establishes a feedback loop, rendering advice such as whether different game enemies should be used, game routes to develop further, how much gamers enjoy some portions of the game and how much they dislike others. The real time changes may include such things as using a favorite enemy more often or increasing game attributes that are more engaging without interrupting use. Real time game change may include changing a game file in a cloud server by inputting the report to a generative model trained to generate computer game scenes based on text.

FIG. 3 illustrates an architecture in which a single ML model 300 is used to generate reports based on multiple input data modalities. These modalities may include clips 302 of recorded play of the video game. The input data may further include clips 304 of video that is similar to the video game under test.

Moreover, the input data may include text 306 from an image-to-text generator, typically another ML model, that processes images from the computer game to generate textual description of the action. The input data also may include text 308 from audio and/or typed-in chat from gamers during play of the computer game. Additionally, the input data may include text 310 from Internet sites such as Twitch describing the reaction of gamers to the computer game.

As further shown in FIG. 3, the input data may include textual questions 312 derived from a prior iteration of ML model 300 processing. For example, the model 300 may have generated a report and based on that report formulated its own question to be used as input to a subsequent iteration. The questions alternatively may be input by gamers along with their referred answers.

Screen shots 314 of the game as posted on social media by gamers may be input to the ML model 300. Also, times of day 316 of when gamers played the computer game may be input as well as game help access data 318 indicating, e.g., the frequencies with which gamers accessed specific help topics during play of the game.

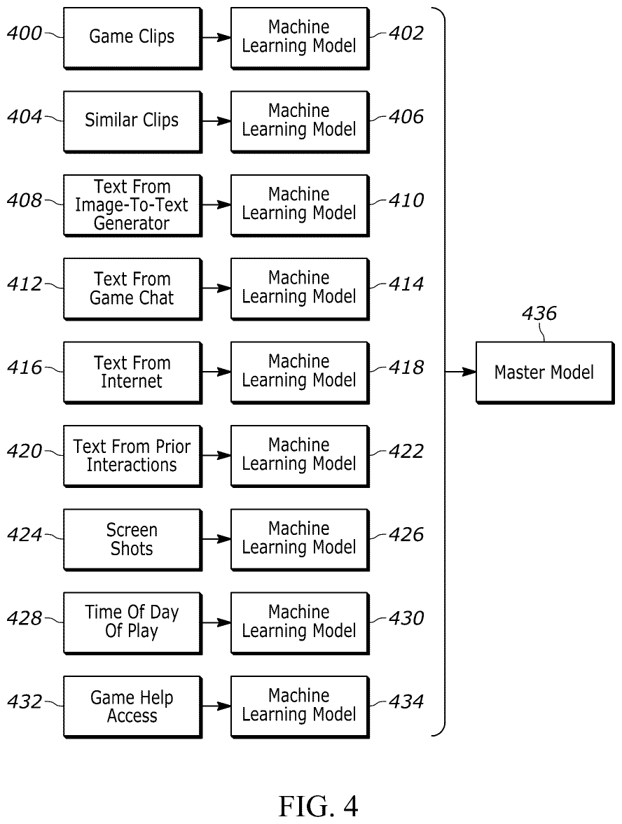

FIG. 4 illustrates an alternate architecture that uses plural ML models. Clips 400 of recorded play of the video game may be input to first ML model 402 while clips 404 of video that is similar to the video game under test may be input to a second ML model 406. In some embodiments, since the clips 400, 404 are both video, they may be input to a single ML model, i.e., the ML models 402, 406 may be combined into one.

Moreover, text 408 from an image-to-text generator, typically another ML model, that processes images from the computer game to generate textual description of the action may be input to a third ML model 410. Text 412 from audio and/or typed-in chat from gamers during play of the computer game may be input to a fourth ML model 414. Additionally, text 416 from Internet sites such as Twitch describing the reaction of gamers to the computer game may be input to a fifth ML model 418 while textual questions 420 derived from a prior iteration of ML model processing may be input to a sixth ML model 422. In some embodiments, since the text 408, 412, 416, 420 are all text, they may be input to a single ML model, i.e., the ML models 410, 414, 418, 422 may be combined into one.

Screen shots 424 of the game as posted on social media by gamers may be input to a seventh ML model 426. Also, times of day 428 of when gamers played the computer game may be input to an eighth ML model 430 while game help access data 432 indicating, e.g., the frequencies with which gamers accessed specific help topics during play of the game may be input to a ninth ML model 434.

The outputs of the ML models shown in FIG. 4 may be sent to a master ML model 436 trained to aggregate the various outputs of the other ML models into a single report.

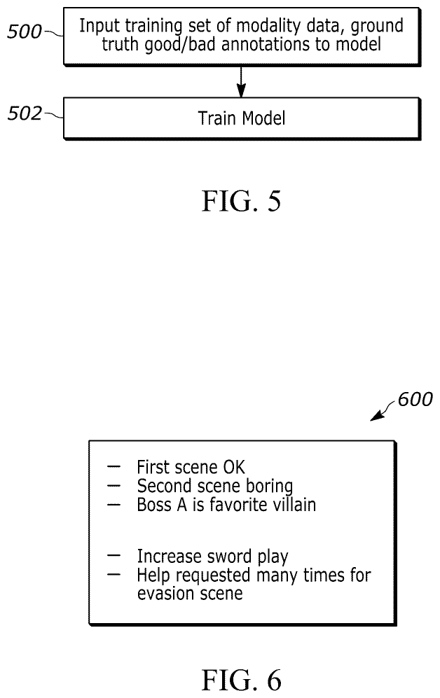

FIG. 5 illustrates example training logic that may be employed for any ML model described herein. A training set of data is input to the model at state 500 to train the model at state 502. The training set includes samples of data in the modality the ML model is intended to process along with ground truth annotations indicating whether samples are good, bad, should be surfaced in a report, should not be surfaced in a report, indicate better weapons or different enemies or game routes should be used, etc.

FIG. 6 illustrates an example report 600 from the report-generating ML model. An example report, in this case shown as text, may indicate that a first game scene is acceptable as is whereas a second scene was found by gamers to be boring. The report 600 also may indicate a favorite enemy, in the example shown, Boss “A”, so that the game may be modified to show more of Boss A. The report may also indicate that gamers liked a particular action in the game such as sword play so that that particular action can be increased in a modified version of the game. The report may also indicate topics or scenes for which help was requested at a high frequency. These are but examples of information the report may contain and may be used to modify the game.

While the particular embodiments are herein shown and described in detail, it is to be understood that the subject matter which is encompassed by the present invention is limited only by the claims.

What is claimed is:

1. An apparatus comprising:
at least one processor system configured to:
input to one or more machine learning (ML) models information related to play of a computer game; and
execute the one or more ML models to generate a report identifying at least a first portion of the computer game having a first quality and at least a second portion of the computer game having a second quality.

2. The apparatus of claim 1, wherein the information comprises captured clips of the computer game.

3. The apparatus of claim 2, wherein the information comprises number of views of the captured clips.

4. The apparatus of claim 2, wherein the information comprises number of views of clips similar to the captured clips.

5. The apparatus of claim 1, wherein the information comprises captured comments of gamers playing the computer game.

6. The apparatus of claim 2, wherein the information comprises text related to the captured clips.

7. The apparatus of claim 1, wherein the information comprises internet comments related to the computer game.

8. The apparatus of claim 1, wherein the processor system is configured to change the computer game using output of the one or more ML models.

9. The apparatus of claim 1, wherein the report is a first report and the information comprises one or more questions derived from the first report to cause the one or more ML models to generate a second report.

10. An apparatus comprising:
computer memory that is not a transitory signal and that comprises instructions executable by at least one processor system to:
identify text related to play of a computer game;
input the text to one or more machine learning (ML) models; and
use output of the one or more ML models to change the computer game.

11. The apparatus of claim 10, wherein the instructions are executable to input captured clips of the computer game to the one or more ML models.

12. The apparatus of claim 11, wherein the instructions are executable to input number of views of the captured clips.

13. The apparatus of claim 11, wherein the instructions are executable to input number of views of clips similar to the captured clips.

14. The apparatus of claim 10, wherein the text comprises captured comments of gamers playing the computer game.

15. The apparatus of claim 10, wherein the text comprises internet comments related to the computer game.

16. The apparatus of claim 10, wherein the text comprises output of the one or more ML models.

17. A method, comprising:
inputting information related to plural game play sessions of a computer game to one or more ML models; and
executing the ML models to output indication of game play.

18. The method of claim 17, wherein the information comprises output of one or more ML models.

19. The method of claim 17, comprising changing the computer game using output of the one or more ML models.

20. The method of claim 17, wherein the information comprises captured clips of the computer game and/or number of views of the captured clips and/or number of views of clips similar to the captured clips and/or comments of gamers playing the computer game.
